(19) United States
(12) Patent Application Publication
(10) Pub. No.: US 2025/0304880 A1
(43) Pub. Date: Oct. 2, 2025

(54) SOLID EFFERVESCENT COMPOSITIONS

(71) Applicant: 3M INNOVATIVE PROPERTIES COMPANY, Saint Paul, MN (US)

(72) Inventors: Yifan Zhang, Woodbury, MN (US); Lylien Zhang, South St. Paul, MN (US)

(21) Appl. No.: 18/876,363

(22) PCT Filed: Jun. 28, 2023
(86) PCT No.: PCT/US2023/026500

§ 371 Date: Dec. 18, 2024

Related U.S. Application Data
(60) Provisional application No. 63/367,276, filed on Jun. 29, 2022.
(60) Provisional application No. 63/472,959, filed on Jun. 14, 2023.

(51) Int. Cl. C11D 1/12; C11D 1/04; C11D 3/00; C11D 3/37; C11D 17/00

(52) U.S. Cl. CPC C11D 1/12; C11D 1/04; C11D 3/0052; C11D 3/3707; C11D 17/0056; C11D 2111/14

(57) ABSTRACT

In one embodiment, the present invention is cleaning article including an inorganic binder, a gas generator, a strong acid having a pKa of between about-3 and about 2, a weak acid having a pKa of between about 2.5 about 5, wherein a ratio of the strong acid to the weak acid is between about 50:1 and about 1:50, and at least about 0.1% water. When the cleaning article has a diameter of about 48 mm and a height of about 21 mm with a recess diameter of about 29.8 mm, a recess height of about 12.8 mm, and a mass of about 40 grams, the cleaning article has a tablet breaking force of at least about 10 lbf and a dissolution time of between about 1 minute and about 60 minutes.

### FIELD OF THE INVENTION

The present invention relates generally to the field of cleaning compositions. In particular, the present invention is a cleaning composition for toilets.

### BACKGROUND

Cleaning toilets is an undesirable but necessary task. Current methods of cleaning toilets commonly involve applying a cleaning agent within a toilet bowl and then scrubbing the toilet bowl with a handheld tool. The handheld tool generally includes bristles or a cleaning head that can be used to scour the inner surface of the toilet bowl, removing debris and stains. Due to the need to manually scrub the toilet bowl, the person cleaning the toilet must be in close proximity to the toilet, a condition which most people find unappealing.

In an attempt to create more distance from the toilet while cleaning it, various products have been developed that can be dropped into a toilet bowl to clean the debris and stains without the need for manually scrubbing the toilet bowl. However, most of these products include bleach or other harsh chemicals with their unpleasant, harsh odor and problematic environmental profile, to kill microbial soils. Other products do not include bleach, but do not clean the toilet bowl as thoroughly.

### SUMMARY

In one embodiment, the present invention is cleaning article including an inorganic binder, a gas generator, a strong acid having a pKa of between about-3 and about 2, a weak acid having a pKa of between about 2.5 about 5, wherein a ratio of the strong acid to the weak acid is between about 50:1 and about 1:50, and at least about 0.1% water. When the cleaning article has a diameter of about 48 mm and a height of about 21 mm with a recess diameter of about 29.8 mm, a recess height of about 12.8 mm, and a mass of about 40 grams, the cleaning article has a tablet breaking force of at least about 10 lbf and a dissolution time of between about 1 minute and about 60 minutes.

In another embodiment, the present invention is solid cleaning composition including an inorganic binder that reacts with water to harden to form a hardened structure, a gas generator, a strong acid having a pKa of between about −3 and about 2 and a weak acid having a pKa of between about 2.5 about 5, wherein the strong acid and the weak acid are present in a ratio of between about 50:1 and about 1:50, and an aqueous polymer.

### DETAILED DESCRIPTION

The present invention is a composition that can be used for making compressed cleaning articles. The composition provides effervescence, foaming, and acidity after being dissolved in water. In addition, the composition can be compressed into a solid article at room and low temperatures. This composition has good stability at both room temperature and elevated temperatures. In one embodiment, the composition can be used along with other materials such as surfactants, fragrance, abrasives, minerals, biocides, antimicrobials, and colorants to allow the creation of a wide spectrum of cleaning articles. In addition, the composition of the present invention is environmentally friendly, being benign to humans and the environment. The composition is fully dissolvable in water and leaves minimal residue after cleaning. The key characteristics of this composition can be tuned to specifically allow enhanced oxidizing power, acidity or effervescence as needed by product development needs. In addition, the composition of the present invention also provides a layer of protection on the surface being cleaned, allowing for easier subsequent cleaning of the surface. The composition can be molded under pressure at room temperature into a cleaning article. The cleaning article can gradually dissolve in the presence of water, providing effervescence, foaming, acidity, and abrasives properties to enable effective cleaning. In one embodiment, the composition is used to clean and/or remove stains such as hard water stains from toilet bowls.

The composition generally includes an inorganic binder, an organic binder, a gas generator, a strong acid, a weak acid, and a water-containing liquid. In one embodiment, the composition includes between about 0.1 wt % and about 30 wt % inorganic binder, between about 0.1 wt % and about 30 wt % organic binder, between about 5 wt % and about 60 wt % gas generator, between about 1 wt % and about 70 wt % strong acid, between about 1 wt % and about 70 wt % weak acid, and between about 0.1 wt % and about 20 wt % water-containing liquid. In particular, the composition includes between about 1 wt % and about 5 wt % inorganic binder, between about 1 wt % and about 20 wt % organic binder, between about 10 wt % and about 40 wt % gas generator, between about 5 wt % and about 60 wt % strong acid, between about 5 wt % and about 60 wt % weak acid, and between about 1 wt % and about 10 wt % water-containing liquid.

The inorganic and organic binders function to maintain the components of the composition together. The binders must be strong enough to hold the mechanical integrity and provide hardness to the composition until the composition comes into contact with water, at which time it can dissolve. The binders can chemically or physically hold together the components of the composition, forming covalent bonds, ionic bonds, hydrogen bonds, Van der Waals interactions, or other secondary interactions, in the presence of the water-containing liquid. The binders can be chemically reactive or unreactive during the binding process.

The inorganic binder reacts with water to cause the composition to harden. To harden means that the inorganic binder reacts with water to form a new hydrated form, or the inorganic binder condenses and crosslinks in the presence of water. The hardened inorganic binder provides structural support to the composition and makes it resistant to deterioration caused by water. During the hardening process, the inorganic binder can form hydrogen bonding with other components, improving the structural integrity of the composition. Compared to an unreactive binder, the use of an inorganic binder that is reactive with water can significantly improve the hardness and mechanical integrity of the composition after the composition is compressed at room temperature under the same amount of force. After forming a compressed article, the composition containing the reactive inorganic binder can maintain enough hardness, mechanical integrity, and durability for scrubbing and cleaning with minimal swelling of the formed geometry, for example, when in contact with water inside a toilet bowl. It is the strong bonding ability of the reactive inorganic binder that enables the durability of the compressed article when used in water or in a wet environment. The durability of the compressed article in a wet state can be quantified by the number of cycles that the compressed article can move back and forth linearly with a selected path length (5 cm, 10 cm, 20 cm) and speed, or selected number of cycles on a circular path and speed, under certain applied weight (0.5 kg, 1.0 kg, 2.0 kg, 5 kg, 10 kg) in wet state, on a suitable machine, for example, a Taber Linear Abraser or Taber Rotary Platform Abrasion Tester (North Tonawanda, NY). The wet state means the compressed article is immersed in water, and then taken out, or stays immersed in water, during testing. To simulate the use of the compressed article in water or in a wet environment, the compressed article with a cylindrical geometry (diameter of 4 cm, height of 0.25 cm, 0.38 cm, 0.50 cm or 0.56 cm) is first immersed in water to allow complete penetration of water into the compressed article, pressed against a hard surface, then moved back and forth with a path length of about 20 cm held by hand. The compressed article is considered to show sufficient “wet hardness”, that is, sufficient, mechanical integrity, and durability when used in wet state. The compressed article effervesces and foams when rubbed against the hard surface with force applied by hand and gradually loses mass during the simulated cleaning process.

Compressed articles containing unreactive binders will lose their hardness and mechanical integrity or swell when used in water within a short period of time, for example, less than about 2 minutes, and particularly about 30 seconds, depending on the size of the article. The hardness of the composition can be measured, for example, by compressing a durometer for Shore Hardness A or D on the surface of the composition following procedures described in ASTM D 2240-00. Aged hardness is the hardness measured on a compressed composition aged at room temperature in air for two weeks. Example of a particularly suitable reactive inorganic binders include, but are not limited to: calcium sulfate hemihydrate, anhydrous calcium sulfate, sodium silicate, sodium metasilicate, potassium silicate, potassium metasilicate, lithium metasilicate, lithium silicate, cement, and combinations thereof. An example of a particularly suitable reactive inorganic binder includes, but is not limited to, formulated binder compositions based on calcium sulfate hemihydrate, such as DURABOND 20, DURABOND 45, and DURABOND 90 available from USG, located in Chicago, IL.

The water or water-containing liquid functions as a reactant with the inorganic binder, serves as a medium for other components in the composition to react, as well as serves as the carrier of additives. The reactive inorganic binder can react with water in the water-containing liquid to harden and provide hardness and mechanical integrity to the composition. The water in the water-containing liquid can also serve as the medium for the acid and gas generator to react and generate more water, which creates hydrogen bonding in the composition to improve hardness and mechanical integrity. The water-containing liquid has a water content sufficient to react with the binder. In one embodiment, the water-containing polymer is a hydrophilic polymer that not only provides water to interact with the inorganic binder, but also leaves a hydrophilic polymer film on the surface for easier cleaning after the compressed composition dissolves. In one embodiment, the water-containing liquid has a water content of at least about 0.1% and particularly at least about 1 wt %. Examples of suitable water-containing liquids include, but are not limited to: water, aqueous solution of inorganic compounds, aqueous solution of polymers, aqueous dispersion of polymers, aqueous dispersion of organic molecules, liquid organic compounds, mixtures of liquid water and organic compounds, aqueous solutions of organic compounds, and combinations thereof. Examples of suitable liquids include, but not limited to: deionized water, aqueous solution of calcium chloride, aqueous solution of calcium acetate, aqueous solution of sodium acetate, aqueous solution of polyacrylic acid and its sodium salt, aqueous solution of polyvinyl alcohol, aqueous solution of polyvinylpyrrolidone, aqueous solution of polyethylene glycol, aqueous solution of polyethylenimine, aqueous solution of polystyrene sulfonate, aqueous solution of polyester, aqueous dispersion of polyurethane, aqueous dispersion of polyvinyl acetate, aqueous dispersion of styrene butadiene rubber, aqueous dispersion of polyacrylate, aqueous dispersion of polyamide, aqucous dispersion of polyolefin, aqucous dispersion of polyacrylic acid acrylamide, aqueous dispersion of other hydrophilic polymers, aqueous dispersion of rosin and its derivatives, mixture of water and acetic acid, mixture of water and lactic acid, aqueous solution of glycolic acid, and aqueous solution of gluconic acid, aqueous dispersion of fragrance, aqueous dispersion of pigment, aqueous solution of dye, and combinations thereof. Examples of commercially suitable water-containing liquids include, but is not limited to: Mirapol Surf-S 110, 500, and 900 available from Solvay, Brussels, Belgium; Sorez™ 100, HS 205 available from Ashland, Wilmington, DE, USA; Noverite™ K-732, K-739 from Lubrizol, Brecksville, OH, USA; and Sokalan available from BASF, Ludwigshafen, Germany.

The gas generator functions as an effervescent agent to create foam/bubbles. By producing foam and/or bubbles, the composition is capable of reaching additional surface area. The gas generator is a basic component that interacts with the acid in the composition to provide effervescence. Examples of suitable gas generators include, but are not limited to: carbon dioxide generators and oxygen generators. Examples of suitable carbon dioxide generators include, but are not limited to: bicarbonate salts of Group I metals, of Group II metals and of other cations, including ammonium, alkyl (mono-, di-, or tri-) ammonium, or those of transition metals; carbonate salts of Group I metals, of Group II metals, and of other cations, including ammonium, alkyl (mono-, di-, or tri-) ammonium, or those of transition metals; and percarbonate salts of Group I metals, of Group II metals, and of other cations, including ammonium, alkyl (mono-, di-, or tri-) ammonium, or those of transition metals. Examples of particularly suitable carbon dioxide generators include, but are not limited to: sodium carbonate, sodium bicarbonate, potassium carbonate, potassium bicarbonate, and calcium bicarbonate.

In order to produce maximum foam in the effervescent system of the composition, the normality ratio of acid and base in the composition should be about 1. The normality ratio is defined as the equivalent mole of acidic functionality vs. the equivalent mole of basic functionality in the formulations. As the ratio deviates from 1, the total amount of foam in the system will decrease accordingly. In one embodiment, the composition has an acid to base ratio of between about 10:1 and about 1:10, particularly between about 5:1 and about 1:5, and more particularly between about 3:1 and about 1:3.

Examples of suitable oxygen generators include, but are not limited to: hydrogen peroxide; peracetic acid generated from sodium percarbonate/TAED (tetraacetylethylenediamine); percarbonate salts of Group I metals, of Group II metals and of other cations, including ammonium, alkyl (mono-, di-, or tri-) ammonium, or those of transition metals; chlorate and perchlorate salts of Group I metals, of Group II metals and of other cations, including ammonium, alkyl (mono-, di-, or tri-) ammonium, or those of transition metals; superoxide salts of Group I metals, of Group II metals and of other cations, including ammonium, alkyl (mono-, di-, ortri-) ammonium, or those oftransition metals; and peroxide salts of Group I metals, of Group II metals and of other cations, including ammonium, alkyl (mono-, di-, ortri-) ammonium, or those of transition metals.

The acids function as both an effervescent agent and a cleaning agent. The composition includes a strong acid and a weak acid. The strong and weak acid must be present in a particular ratio in order to provide foaming as well as desirable dissolution times. In one embodiment, a weight ratio of the strong acid to the weak acid is between about 50:1 and about 1:50, and in particular, between about 11:1 and about 1:11. In one embodiment, a normal ratio of the strong acid to the weak acid is between about 3:1 and about 1:3, and in particular, about 1:1.

A strong acid is defined as an acid having a pKa of between about −3 and about 2. The strong acid functions to provide quick foaming and is generally less hydroscopic. In one embodiment, the strong acid can also perform a disinfecting function. In one embodiment, the strong acid is one of an alkyl sulfonic acid, an aryl sulfonic acid, and oxalic acid. Examples of suitable alkyl sulfonic acids and aryl sulfonic acids include, but are not limited to: sulfamic acid, p-toluenesulfonic acid, and methanesulfonic acid.

A weak acid is defined as an acid having a pKa of between about 2.5 and about 5. The weak acid is generally more hydroscopic and the strong acid and can thus provide strong binding, resulting in increased tablet strength. The weak acid can also contribute to slow initial foaming, but high total foaming. In one embodiment, the weak acid is a carboxylic acid. Examples of suitable weak acids include, but are not limited to: formic acid, acetic acid, propionic acid, butyric acid, lactic acid, sorbic acid, fumaric acid, malic acid, tartaric acid, citric acid, benzoic acid, adipic acid, ascorbic acid, and glycolic acid.

Other additives can be included in the composition to perform various functions. Examples include, but are not limited to: chelating agents, surfactants, oxidizers, biocides, antimicrobial agents, anti-caking agents, hydrophilic agents, dispersants, co-binders, processing aids, fillers/tougheners, softeners, abrasive particles, desiccants, mold release agents, lubricants, disintegrants, cleaning agents, coupling agents, photoinitiators, thermal initiators, viscosity modifiers, adhesion promoters, grinding aids, wetting agents, dispersing agents, light stabilizers, antioxidants, anti-foam agents, coloring agents, dyes, pigments, and fragrances. Particularly suitable additives include components which aid in improving the stability of the composition before compression and formation for a compressed article. Examples include anti-caking agents, dispersants, and co-binders. Particularly suitable additives to aid the releasing of the compressed article include, but are not limited to: mold release agents and lubricants.

The composition may also include an organic binder. The organic binder is added to the composition in addition to the inorganic binder to improve the overall tablet strength. In particular, the organic binder improves the dropping strength of the final product, increasing its durability. In addition, the organic binder aids in the manufacturing process of the compressed cleaning article by preventing brittleness of the composition.

Examples of suitable organic binders include, but are not limited to: sugars (such as glucose, fructose, galactose, sucrose, lactose, maltose, and liquid glucose), organic acid salts (such as sodium acetate, calcium acetate, sodium propanoate, sodium glycolate, and sodium citrate), polymers (such as hydroxypropyl cellulose, methyl cellulose, ethyl cellulose, hydroxy propyl methyl cellulose, sodium carboxy methyl cellulose, gelatin, gum arabic chitosan, alginic acid, starch, polyvinylpyrrolidone, polyvinyl alcohol, polyethylene glycol, acrylate polymers, polyurethane, styrene-butadiene rubber, polyester, polyamide, polyethylenimine, vinyl polymer), and combinations thereof. An example of a particularly suitable organic binder includes polyethylene glycol, and particularly a low molecular weight polyethylene glycol. Examples of particularly suitable polyethylene glycols include polyethylene glycols having an average molecular weight range of less than about 20,000 g/mol, particularly between about 400 g/mol and about 10,000 g/mol, and more particularly between about 4,000 g/mol and about 6,000 g/mol. The average molecular weight of the solid polyethylene glycol allows the polyethylene glycol to dissolve quickly in water. The binding strength of polyethylene glycols within this average molecular weight range ensures that the compressed composition is not too hard, which could result in a long dissolution time. As used herein, “molecular weight” refers to weight average molecular weight, as measured using standard gel permeation chromatography methods known in the art.

When a processing aid is included for tablet or tablet manufacturing, it will reduce the stickiness of tablet onto the tooling surface that will allow the tablet to be released easily from the punch of the tooling. The process aid can be stearate such as magnesium stearate, mineral oil, and silicates.

When a chelating agent is included in the composition, the chelating agent primarily functions as complex forming agents with metal ions dissolved in water or metal ions precipitated on toilet surface as stains. It also promotes cleaning as well as foaming. Examples of suitable chelating agents include, but are not limited to: citric acid and its sodium salts, ethylenediaminetetraacetic acid (EDTA) and its sodium salts, ethylene glycol tetraacetic acid (EGTA) and its sodium salts, and maleic acid and its sodium salts.

When a surfactant is included in the composition, the surfactant is used as a cleaning and foaming agent. Examples of suitable surfactants include, but are not limited to: anionic surfactants, nonionic surfactants, cationic surfactants, zwitteronic surfactants, amphoteric surfactants, oligomeric and polymeric surfactants. Examples of suitable anionic surfactants include, but are not limited to: alkyl and alkyl ether sulfates, sulfated monoglycerides, sulfonated olefins, alkyl aryl sulfonates, primary or secondary alkane sulfonates, alkyl sulfosuccinates, acid taurates, alkyl sulfoacetates, acid isethionates, alkyl glycerylether sulfonate, sulfonated methyl esters, sulfonated fatty acids, alkyl phosphates, acyl glutamates, acyl sarcosinates, alkyl lactylates, anionic fluorosurfactants, sodium lauroyl glutamate, and combinations thereof. Additional suitable anionic surfactants include those disclosed in U.S. Patent Application No. 61/120,765 and those surfactants disclosed in Mccutcheon's Detergents and Emulsifiers, North American Edition (1992), Allured Publishing Corp. Examples of suitable nonionic surfactants include, but are not limited to: polyoxyethylenated alkyl phenols, polyoxyethylenated alcohols, polyoxyethylenated polyoxypropylene glycols, glyceryl esters of alkanoic acids, polyglyceryl esters of alkanoic acids, propylene glycol esters of alkanoic acids, sorbitol esters of alkanoic acids, polyoxyethylenated sorbitor esters of alkanoic acids, polyoxyethylene glycol esters of alkanoic acids, polyoxyethylenated alkanoic acids, alkanolamides, N-alkylpyrrolidones, alkyl glycosides, alkyl polyglucosides, alkylamine oxides, and polyoxyethylenated silicones. Examples of suitable cationic surfactants include, but are not limited to, those selected from the “quaternary ammonium” class of materials including but not limited to; cetyltrimethylammonium chloride, behenyltrimethylammonium chloride, stearyltrimethylammonium chloride, cetylpyridinium chloride, octadecyltrimethylammonium chloride, hexadecyltrimethylammonium chloride, octyldimethylbenzy lammonium chloride, decyldimethylbenzy lammonium chloride, stearyldimethylbenzy lammonium chloride, didodecyldimethylammonium chloride, dioctadecy ldimethy lammonium chloride, distearyldimethylammonium chloride, tallowtrimethy lammonium chloride, cocotrimethylammonium chloride, dipalmitoylethyldimethylammonium chloride, PEG-2 oleylammonium chloride, and salts of these, where the chloride is replaced by halogen, (e.g., bromide), acetate, citrate, lactate, glycolate, phosphate nitrate, sulphate, or alkylsulphate. Examples of suitable zwitteronic and amphoteric surfactants include, but are not limited to: amine oxides, betaines (carboxylic acid/quaternary ammonium or carboxylic acid/phosphonium), sulfobetaines, or carboxybetaines, sultaines (sulfonic acid/quaternary ammonium or sulfonic acid/phosphonium), amino acid derivatives, imidizoline derivatives, lecithins, and phospholipids. Examples of suitable polymeric surfactants include, but are not limited to: block copolymers of ethylene oxide and fatty alkyl residues, block copolymers of ethylene oxide and propylene oxide, hydrophobically modified polyacrylates, hydrophobically modified celluloses, silicone polyethers, silicone copolyol esters, diquatemary polydimethylsiloxanes, and co-modified amino/polyether silicones.

When the composition includes an oxidizer, the oxidizer functions to oxidize organic stains and to remove bacteria. Examples of suitable oxidizers include, but are not limited to: sodium persulfate, potassium persulfate, ammonium persulfate, sodium percarbonate, carbamide peroxide, complex of polyvinylpyrrolidone with hydrogen peroxide, sodium perborate, peracetic acid, and combinations thereof. An example of a suitable commercially available oxidizer includes, but is not limited to, Oxone, available from Dupont, located in Wilmington, DE. In one embodiment, when the solid-state composition includes oxidizer, the solid-state composition includes up to about 15 wt % oxidizer, and particularly up to about 5 wt % oxidizer.

The composition may include an anti-caking agent to aid in the stability of the final product. In one embodiment, the anti-caking agent is hydrophobic. Examples of suitable anti-caking agents include, but are not limited to: fumed silica, fumed alumina, clay, and corn starch. In one embodiment, when the solid-state composition includes oxidizer, the solid-state composition includes up to about 15 wt % anti-caking agent, and particularly up to about 5 wt % anti-caking agent.

The composition may optionally include a biocide to remove bacteria. Examples of suitable biocides include, but are not limited to: benzalkonium chloride, sodium dichloroisocyanurate, benzisothiazolinone chlorhexidine chlorhexidine, quaternary ammonium derivatives, and combinations thereof. In one embodiment, when the composition includes a biocide, the solid-state composition includes up to about 5 wt % biocide, and particularly up to about 2 wt % biocide.

The composition has an acidic pH, making it favorable to cleaning surfaces, such as a toilet bowl, which are etched by protons in aqueous solution. In addition, hard water stains and lime scales can be dissolved under acidic conditions. A basic pH is favorable to forming hard water stains and deposits of organic matters on toilet bowl. Thus, it is desirable for the composition to have an acidic pH. In one embodiment, the composition has a pH of between about O and about 6, particularly between about 1 and about 5, and particularly between about 2 and about 5 when dissolved in water.

Due in part to its low pH, the composition can effectively remove various debris and stains, such as hard water stains and lime scale. In practice, the composition must come into contact with a sufficient amount of water or a mixture of water and polar solvents to begin the reactions needed to clean the intended surface. Once the composition is exposed to water, the composition will begin to dissolve and foam. Water serves as a media for reactions to take place. The acid and gas generator react to release carbon dioxide which rises to the surface through aqueous solution of surfactants, creating bubbles in solution and forming a foam layer on surface. The foaming allows the composition to contact hard to reach surfaces, such as the underside of the inner surface of a toilet bowl. In one embodiment, with 40 g samples in 2 liters of water, a sufficient amount of foam is produced to have a foam height of at least about 0.1 cm, at least about 0.5 cm, at least about 0.75 cm, at least about 1 cm, at least about 1.25 cm, at least about 1.5 cm, at least about 1.75 cm, at least about 2 cm, at least about 3.0 cm, and at least about 3.5 cm after a one to five minute duration once the sample tablet is submerged in water.

The composition has two key characteristics: cleaning efficacy and the ability to be molded into various geometries under room temperature. The cleaning efficacy includes effervescence, foaming, acidity, and abrasive properties to remove hard water stain, limescale and organic stains from the surface to be cleaned. In one embodiment, the composition can be added into water wherein the cleaning efficacy is static without the use of mechanical force. In one embodiment, the composition can be used as a scrubber on a surface wherein the cleaning efficacy is a convolution of static cleaning efficacy and scrubbing by mechanical force. Additional features of the composition including fragrance, color, oxidizing power, and antimicrobial properties that can be incorporated into the basic formula of the composition to allow the creation of a wide spectrum of cleaning products. In one embodiment, the composition can remove at least about 25%, at least about 50%, at least about 60%, at least about 70%, at least about 80%, at least about 90%, at least about 95% of hard water stains. In one embodiment, the solid-state composition can remove at least about 25%, at least about 50%, at least about 60%, at least about 70%, at least about 80%, at least about 90%, at least about 95% of lime scale.

After being molded into a condensed, solid-state format, the composition provides adequate mechanical integrity, hardness, toughness, and durability to be used on a hard surface. In one embodiment, the solid-state composition is in the form of a tablet or pod that can be dropped into, for example, a toilet bowl, to provide cleaning. In one embodiment, the composition can be molded into a cleaning head and used in conjunction with a handheld tool. This provides a dissolvable head that functions as a scrubbing tool as well as providing the needed chemicals for cleaning. The solid-state composition thus has dual functionality of being used as a tablet and/or used on a handle. The solid-state composition can also first be used on a handle for cleaning with mechanical force and then released into water for static cleaning.

The solid, compressed composition must have a certain hardness and durability such that it does not immediately dissolve or break apart when it is contacted with water and must remain in a solid-state form for an amount of time sufficient to contact and clean a surface. The tablet hardness is also described as the tablet breaking force which can be measured by most commercial instruments. The load at which the tablet fails across the diameter is recorded as the tablet breaking force or hardness. A tensile tester is modified for our tablet hardness measurement due to relatively large tablet size. Tablet breaking force is dependent on the physical parameters of the tablet including mass, geometric size, and shape. The inclusion of a recess in the tablet will also impact breaking force. In one embodiment, when the solid compressed composition has a mass of 40 grams and a diameter of 48 mm (+1.0 mm) and a height of 21.0 mm (+1.0 mm) with a recess diameter of 29.8 mm (+1.0 mm) and a recess height of 12.8 mm (+1.0 mm) and is rectangularly shaped with curved comers, then the tablet breaking force is at least about 10 lbf, about 15 lbf, about 20 lbf, and particularly of at least about 25 lbf. In one embodiment, the solid, compressed composition has an aged Shore A hardness of at least about 30, particularly at least about 30, more particularly at least about 50 and about 100, and even more particularly at least about 80. In one embodiment, the solid, compressed composition has an aged Shore D hardness of between about 10 and about 100, and particularly between about 20 and about 70. The amount of time the composition remains in a solid-state form can be measured as dissolution time, defined as the time that a 40-gram solid-state composition takes to disintegrate and dissolve when immersed in 2 liter of water without agitation after the 40-gram solid, compressed composition has been aged in the air at ambient conditions for two weeks. The solid, compressed composition has a dissolution time that is optimal for scrubbing the surface to be cleaned. In one embodiment, the solid, compressed composition has a dissolution time of between about 1 minute and about 60 minutes, particularly between about 5 and about 40 minutes, and particularly between about 10 and about 30 minutes.

To make the solid-state composition of the present invention, the components are mixed together. If there is a fragrance, the fragrance is mixed with sodium carbonate. The sodium carbonate and fragrance are first mixed, and then mixed with any surfactants to form a pre-mixture, after which the pre-mixture is mixed with the mixture of remaining components. The final mixture of the composition is added into a cavity or mold where mechanical force is applied, for example by a hydraulic or a mechanical press, to compress the mixture into a compressed article. The solid, compressed article can take on any geometry without departing from the intended scope of the present invention. After released from the cavity or mold, the compressed article is aged in the air or in a sealed environment at ambient conditions to allow it to harden over time. In one embodiment, the resulting solid-state composition is compressed to form a tablet. In one embodiment, the solid-state composition is wrapped by a water-soluble polymer film to form a pod.

### EXAMPLES

Unless otherwise noted or readily apparent from the context, all parts, percentages, ratios, etc. in the Examples and the rest of the specification are by weight.

### Materials

TABLE 1
Materials

| Designation | Description | Source |
|---|---|---|
| Citric Acid | Anhydrous citric acid, 100% | Cargill, USA |
| Na₂CO₃ | Sodium carbonate | Genesis Alkali, USA |
| Sodium Salt | Sodium dodecyl sulfate | XiLong Scientific Co Ltd, |
| | | PRChina |
| LAL | Sodium lauryl sulfoacetate, available under | Stepan Company, |
| | the trade designation Lathanol ® LAL | Northfield, IL, United |
| | | States |
| Silicate | Precipitated silicate, chemically prepared and | Evonik Industries, Essen, |
| | available under the trade designation | Germany |
| | Sipernat ® 50 S | |
| Sulfamic Acid | Sulfamic acid, 99% | Univar, USA |
| PEG-1 | Polyethylene glycol-1, available under the | Dow Chemical Company, |
| | designation PEG 400 | Midland, MI, United States |
| PEG-2 | Polyethylene glycol-2, available under the | Dow Chemical Company |
| | designation PEG 6000 | |
| Plaster | Calcium Sulfate hemihydrate | USG, USA |
| Sodium | Sodium metabisulfite | Hawkins, USA |
| Metabisulfite | | |
| Blue Dye | Erioglaucine Disodium Salt | Shanghai Dyestuffs |
| | | Research Institute Co Ltd, |
| | | Shanghai, China |
| Polyacrylic | Polyacrylic Acid-1. 45% Polyacrylic Acid | BASF, Ludwigshafen, |
| Acid-1 | Sodium Salt Aqueous Solution, available | Germany |
| | under the trade designation Sokalan ® CP 10 | |
| Polyacrylic | Polyacrylic Acid-1. An aqueous solution of | Solvay USA Inc. Albright, |
| Acid-2 | acrylic polymer, available under the trade | WV, United States |
| | designation Mirapol ® Surf-S 900 | |
| Lemon | Lemon Fragrance | Eanson Fragrance, Foshan, |
| | | PRChina |
| Citrus | Citrus Fragrance | Sozio Inc, Piscataway, NJ, |
| | | United States |

### Test Methods

### Dissolution Time

2000 grams of water was added into a 4-liter beaker, followed by adding a 40-gram sample tablet. The dissolution time of the tablet was recorded when the tablet was completely dissolved without agitation of the solution.

### pH Measurement

pH of dissolved solutions was measured by a Thermo Fisher Scientific (from Minneapolis, MN, United States) ORION STAR PH meter with an ORION ROSS pH Electrode.

### Tablet Foam Height Measurement

2000 grams of water was added into a 4-liter beaker, followed by adding a 40-gram sample tablet. The height of the foam of the effervescent tablet was measured and recorded as it was dissolving after two, three, and five minutes.

### Table Drop Test

The tablet was dropped from either 0.5 m or 1 m above a ceramic tile surface with the tablet bottom facing the tile surface, and the dropping strength of the tablet was rated as a 1 if there were multiple broken pieces, a 2 if there were several broken pieces, a 3 if there were two broken pieces, a 4 if there was cracking on the tablet, and a 5 if the tablet was intact.

### Tablet Strength Measurement

Tablet strength was measured by a Llyod LF Plus Tensile Tester by crushing the tablet in the diameter direction (XY direction), and the calculated force to crush the tablet (defined as the maximum load) in Newtons (N) and Pound-force (lbf) was recorded. The tablets were secured by an in-house fixture.

### Contact Angle Measurement

Surface contact angle (CA), in degrees, of the substrate was measured by a Goniometer (NRL C.A., Model 100-00 115). One micro-liter droplet of deionized water was deposited onto the surface of a ceramic tile substrate coated with a sample solution, a contact angle was measured from one droplet of water by illuminating the droplet and recording the image with a camera. The image was computationally analyzed and contact angle was calculated based on the tangent line.

### Coating Preparation and Coating Durability Measurement

A 10.2 cm×10.2 cm (4 inch×4 inch) black ceramic tile substrate (obtained from Home Depot) was first cleaned with tap water and then dried in air. A sample solution was prepared by mixing in a 4-liter beaker, 980 grams of tap water, followed by adding 20 grams of the sample for ten minutes. The ceramic tile was then placed in the sample solution for either one-or five-minute dwell times, rinsed with water to remove the extra foam on the surface and dried in ambient conditions. A contact angle was immediately measured defined as initial CA (0 minute). The durability of the coating was measured by rinsing the coated tile under running water (flow rate 168 grams/min) for one, three, five, and ten minutes, and the contact angle was measured after it is dried. All the contact angle measurements are the average of triplicate.

### Examples 1-7 (EX1-EX7) and Comparative Examples 1-2 (CE1-CE2)

Quantities (weight percent) of the materials identified in Table 2 were combined and mixed with an Eirich Intensive Mixer for two to twenty minutes.

Tablets with a 48 mm diameter and a 40-gram weight were prepared on a hydraulic press (MTV4-SD-120T-S, MULTITECH, Hong Kong) with the pressing speed of 0.1 m/s and dwell time of 1 s. The approximate force for tableting was around 95 kg/cm².

TABLE 2
Tablet Compositions (weight percent)

| | CE1 | CE2 | EX1 | EX2 | EX3 | EX4 | EX5 | EX6 | EX7 |
|---|---|---|---|---|---|---|---|---|---|
| PEG 1 | 0.3 | 0.3 | 0.3 | 0.3 | 0.3 | 0.3 | 0.3 | 0.3 | 0.3 |
| Blue Dye | 0.01 | 0.01 | 0.01 | 0.01 | 0.01 | 0.01 | 0.01 | 0.01 | 0.01 |
| Sodium | 0.06 | 0.06 | 0.06 | 0.06 | 0.06 | 0.06 | 0.06 | 0.06 | 0.06 |
| Metabisulfite | | | | | | | | | |
| Na₂CO₃ | 24.0 | 24.0 | 23.0 | 23.0 | 23.0 | 23.0 | 23.0 | 23.0 | 23.0 |
| Lemon | 0.3 | 0.3 | 0.3 | 0.3 | 0.3 | 0.3 | 0.3 | 0.3 | 0.3 |
| Sodium Salt | 1.5 | 1.5 | 1.5 | 1.5 | 1.5 | 1.5 | 1.5 | 1.5 | 1.5 |
| LAL | 2.5 | 2.5 | 2.5 | 2.5 | 2.5 | 2.5 | 2.5 | 2.5 | 2.5 |
| Silicate | 0.5 | 0.5 | 0.5 | 0.5 | 0.5 | 0.5 | 0.5 | 0.5 | 0.5 |
| Plaster | 5.0 | 5.0 | 5.0 | 5.0 | 5.0 | 5.0 | 5.0 | 5.0 | 5.0 |
| Citric Acid | 14.0 | 51.0 | 12.0 | 7.0 | 20.0 | 30.0 | 30.0 | 49.0 | 44.0 |
| Sulfamic Acid | 51.83 | 14.83 | 49.83 | 49.83 | 41.83 | 31.83 | 26.83 | 12.83 | 12.83 |
| PEG 2 | 0.0 | 0.0 | 5.0 | 10.0 | 5.0 | 5.0 | 10.0 | 5.0 | 10.0 |
| pH | 2.27 | 3.68 | 2.13 | 2.24 | 2.69 | 3.79 | 4.08 | 4.09 | 4.39 |

Testing was conducted and the results are represented in Table 3.

TABLE 3
Tablet Sample Test Results

| | | | Tablet | Disso- | Tablet Height | | |
|---|---|---|---|---|---|---|---|
| | | | Strength | lution | mm | | |
| | Table Drop | | N | Time | (inches) | | |
| Sample | 0.5 m | 1.0 m | (lbf) | (min:sec) | 2 min | 3 min | 5 min |
| CE1 | 1 | 1 | 114.3 | 6:05 | 12.7 | 22.2 | 28.6 |
| | | | (25.7) | | (0.5) | (0.875) | (1.125) |
| CE2 | 3 | 2 | 273.1 | 9:35 | 9.53 | 12.7 | 15.9 |
| | | | (61.4) | | (0.375) | (0.5) | (0.625) |
| EX1 | 1 | 1 | 161.9 | 6:25 | 6.35 | 9.53 | 15.9 |
| | | | (36.4) | | (0.25) | (0.375) | (0.625) |
| EX2 | 2 | 1 | 124.6 | 7:40 | 5.08 | 8.47 | 12.7 |
| | | | (28.0) | | (0.2) | (0.33) | (0.5) |
| EX3 | 3 | 2 | 234.0 | 7:30 | 6.35 | 11.29 | 22.2 |
| | | | (52.6) | | (0.25) | (0.44) | (0.875) |
| EX4 | 3 | 2 | 254.9 | 7:00 | 6.35 | 9.53 | 15.9 |
| | | | (57.3) | | (0.25) | (0.375) | (0.625) |
| EX5 | 3 | 2 | 304.3 | 8:15 | 3.18 | 6.35 | 12.7 |
| | | | (68.4) | | (0.125) | (0.25) | (0.5) |
| EX6 | 5 | 3 | 225.1 | 9:40 | 4.78 | 11.13 | 4.78 |
| | | | (50.6) | | (0.188) | (0.438) | (0.188) |
| EX7 | 5 | 3 | 298.0 | 10:00 | 3.96 | 4.78 | 6.35 |
| | | | (67.0) | | (0.156) | (0.188) | (0.25) |

### Examples 8-17 (EX8-EX17)

Quantities (weight percent) of the materials identified in Table 4 were combined and mixed with an Eirich Intensive Mixer for two to twenty minutes.

Tablets with a 48 mm diameter and a 40-gram weight were prepared on a hydraulic press (MTV4-SD-120T-S, MULTITECH, Hong Kong) with the pressing speed of 0.1 m/sand dwell time of 1 s. The approximate force for tableting was around 95 kg/cm².

TABLE 4
Tablet Compositions (weight percent)

| | EX8 | EX9 | EX10 | EX11 | EX12 | EX13 | EX14 | EX15 | EX16 | EX17 |
|---|---|---|---|---|---|---|---|---|---|---|
| PEG-1 | 0.3 | 0.3 | 0.3 | 0.3 | 0.3 | 0.3 | 0.0 | 0.0 | 0 | 0 |
| Blue Dye | 0.01 | 0.01 | 0.01 | 0.01 | 0.01 | 0.01 | 0.0 | 0.0 | 0.02 | 0.02 |
| Sodium | 0.06 | 0.06 | 0.06 | 0.06 | 0.06 | 0.06 | 0.0 | 0.0 | 0 | 0 |
| Metabisulfite | | | | | | | | | | |
| Na₂CO₃ | 23.0 | 23.0 | 23.0 | 23.0 | 23.0 | 23.0 | 23.1 | 23.3 | 23 | 23 |
| Lemon | 0.3 | 0.3 | 0.3 | 0.3 | 0.3 | 0.3 | 0.0 | 0.0 | 0 | 0 |
| Citrus | 0.0 | 0.0 | 0.0 | 0.0 | 0.0 | 0.0 | 0.3 | 0.32 | 0.3 | 0.3 |
| Polyacrylic | 1.5 | 1.5 | 1.5 | 1.5 | 1.5 | 1.5 | 3.0 | 0.0 | 0 | 0 |
| Acid-1 | | | | | | | | | | |
| Polyacrylic | 0.0 | 0.0 | 0.0 | 0.0 | 0.0 | 0.0 | 0.0 | 3.0 | 0 | 5 |
| Acid-2 | | | | | | | | | | |
| Sodium Salt | 1.5 | 1.5 | 1.5 | 1.5 | 1.5 | 1.5 | 1.5 | 1.5 | 1.5 | 1.5 |
| LAL | 2.5 | 2.5 | 2.5 | 2.5 | 2.5 | 2.5 | 2.5 | 2.64 | 2.5 | 2.5 |
| Silicate | 0.5 | 0.5 | 0.5 | 0.5 | 0.5 | 0.5 | 0.48 | 0.5 | 0.5 | 0.5 |
| Plaster | 10.0 | 5.0 | 9.7 | 5.0 | 5.0 | 5.0 | 5.0 | 4.96 | 5 | 5 |
| Citric Acid | 10.3 | 11.5 | 10 | 20 | 30 | 48 | 11.0 | 11.1 | 31.1 | 28.6 |
| Sulfamic | 50 | 48.8 | 45.6 | 40.3 | 30.3 | 12.3 | 47.7 | 47.7 | 31.1 | 28.6 |
| Acid | | | | | | | | | | |
| PEG-2 | 0.0 | 5.0 | 5.0 | 5.0 | 5.0 | 5.0 | 5.0 | 5.1 | 5 | 5 |
| pH | 2.0 | 2.2 | 2.5 | 2.7 | 3.4 | 4.2 | 2.8 | 2.5 | 3.7 | 3.7 |

Testing was conducted for EX8-EX13, and their results represented in Table 5.

TABLE 5
Tablet Sample Test Results

| | | | Tablet | Disso- | Tablet Foam | | |
|---|---|---|---|---|---|---|---|
| | | | Strength | lution | Height cm | | |
| | Table Drop | | N | Time | (inches) | | |
| Sample | 0.5 m | 1.0 m | (lbf) | (min:sec) | 2 min | 3 min | 5 min |
| EX8 | 2 | 1 | 112.1 | 6:30 | 15.88 | 25.4 | 31.75 |
| | | | (25.2) | | (0.625) | (1.0) | (1.25) |
| EX9 | 5 | 2 | 252.2 | 7:00 | 6.35 | 12.7 | 22.23 |
| | | | (56.7) | | (0.25) | (0.5) | (0.875) |
| EX10 | 2 | 1 | 219.7 | 7:30 | 4.78 | 9.53 | 15.88 |
| | | | (49.4) | | (0.188) | (0.375) | (0.625) |
| EX11 | 3 | 3 | 228.9 | 7:25 | 6.35 | 12.7 | 20.32 |
| | | | (50.1) | | (0.25) | (0.5) | (0.8) |
| EX12 | 5 | 4 | 432.8 | 8:20 | 4.78 | 6.35 | 12.7 |
| | | | (97.3) | | (0.188) | (0.25) | (0.5) |
| EX13 | 5 | 4 | 653.4 | 8:59 | 6.35 | 12.7 | 15.88 |
| | | | (146.9) | | (0.25) | (0.5) | (0.625) |

5 Tests for Contact Angle Measurement and Coating Durability Measurement were conducted on EX14-EX17 and their results represented in Table 6.

TABLE 6
Tablet Sample Test Results

| | EX14 | | EX15 | | EX16 | EX17 |
|---|---|---|---|---|---|---|
| Running | Dwell Time | | Dwell Time | | Dwell Time | Dwell Time |
| Water Time | (min) | | (min) | | (min) | (min) |
| (min) | 1 | 5 | 1 | 5 | 5 | 5 |
| 0 | 16.6° | 6.0° | 14.0° | 5.0° | 6.0° | 3.0° |
| 1 | 16.3° | 6.0° | 14.0° | 5.0° | — | — |
| 3 | 19.3° | 15.7° | 14.7° | 6.7° | — | — |
| 5 | 23.7° | 18.3° | 20.0° | 7.0° | — | — |
| 7 | — | — | — | — | 12.3° | 6.7° |
| 10 | 28.7° | 30.3° | 20.0° | 12.3° | — | — |
| 13 | — | — | — | — | 19.3° | 6.7° |
| 20 | — | — | — | — | 32.3° | 9.0° |

The Antimicrobial Test above was performed on EX1 and EX16 and results represented in Table 7.

TABLE 7
Antimicrobial Kills in Log Reduction

| | |
|---|---|
| S. Aureus | E. Coli |

| Contact Time: 1 minute | |
|---|---|
| Sample (g) | Water (g) |
| 20 | 2000 |

| | | |
|---|---|---|
| EX1 | 4.59 | 6.28 |
| EX16 | 6.49 | 6.49 |

Although the present invention has been described with reference to preferred embodiments, workers skilled in the art will recognize that changes may be made in form and detail without departing from the spirit and scope of the invention.

What is claimed is:

1. A cleaning article comprising:
an inorganic binder;
a gas generator;
a strong acid having a pKa of between about −3 and about 2;
a weak acid having a pKa of between about 2.5 about 5, wherein a ratio of the strong acid to the weak acid is between about 50:1 and about 1:50; and
at least about 0.1% water,
wherein when the cleaning article has a diameter of about 48 mm and a height of about 21 mm with a recess diameter of about 29.8 mm, a recess height of about 12.8 mm, and a mass of about 40 grams, the cleaning article has a tablet breaking force of at least about 10 lbf and a dissolution time of between about 1 minute and about 60 minutes.

2. The cleaning article of claim 1, further comprising an organic binder.

3. The cleaning article of claim 1, further comprising one of a chelating agent, a surfactant, a hydrophilic agent, a lubricant, a mold release agent, an oxidizer, an antimicrobial agent, a biocide, a fragrance, and an anti-caking agent.

4. The cleaning article of claim 2, wherein the organic binder is a polyethylene glycol.

5. The cleaning article of claim 2, wherein the organic binder is a polyethylene glycol having an average molecular weight range of between about 400 g/mol and about 500,000 g/mol.

6. The cleaning article of claim 1, wherein the strong acid is selected from one of an alkyl sulfonic acid, an aryl sulfonic acid, and oxalic acid.

7. The cleaning article of claim 1, wherein the weak acid is a carboxylic acid.

8. The cleaning article of claim 1, wherein the strong acid and the weak acid are organic acids.

9. The cleaning article of claim 1, wherein the cleaning article has a breaking force of at least about 25 lbf.

10. The cleaning article of claim 1, wherein the cleaning article has cleaning efficiency when used with or without mechanical force.

11. A solid cleaning composition comprising:
an inorganic binder that reacts with water to harden to form a hardened structure;
a gas generator;
a strong acid having a pKa of between about-3 and about 2 and a weak acid having a pKa of between about 2.5 about 5, wherein the strong acid and the weak acid are present in a ratio of between about 50:1 and about 1:50; and
an aqueous polymer.

12. The solid cleaning composition of claim 11, further comprising an organic binder.

13. The solid cleaning composition of claim 12, wherein the organic binder is one of a sugar and organic acid salt.

14. The solid cleaning composition of claim 11, wherein the organic binder is a polyethylene glycol.

15. The solid cleaning composition of claim 11, wherein the solid cleaning composition has a pH of between about O and about 6 when dissolved in water.

16. The solid cleaning composition of claim 11, wherein the strong acid and the weak acid are organic acids.

17. The solid cleaning composition of claim 11, wherein a ratio of the strong acid to the weak acid is between about 11:1 and about 1:11.

18. The solid cleaning composition of claim 11, wherein the cleaning article has a breaking force of at least about 10 lbf.

19. The solid cleaning composition of claim 11, wherein the cleaning article has an aged Shore A hardness of at least about 10 and an aged Shore D hardness of up to about 100.

20. The solid cleaning composition of claim 11, wherein the cleaning article has cleaning efficiency when used with or without mechanical force.
